(19) United States
(12) Patent Application Publication
(10) Pub. No.: US 2014/0129928 A1
(43) Pub. Date: May 8, 2014

(54) METHOD AND SYSTEM FOR REPRESENTING CAPITALIZATION OF LETTERS WHILE PRESERVING THEIR CATEGORY SIMILARITY TO LOWERCASE LETTERS

(71) Applicant: PSYENTIFIC MIND INC., Santa Cruz, CA (US)

(72) Inventor: Dominic William Massaro, Santa Cruz, CA (US)

(73) Assignee: PSYENTIFIC MIND INC., Santa Cruz, CA (US)

(21) Appl. No.: 13/669,522

(22) Filed: Nov. 6, 2012

(51) Int. Cl. G06F 17/24

(52) U.S. Cl. 715/256

(57) ABSTRACT

A computer-implemented method is proposed for representing capitalization in written text by quantitative differences in font size, font, color, boldness, and italics or some combination of these characteristics of lowercase letters rather than by the currently accepted use of uppercase letters. Shape differences between upper and lowercase letters impede learning to read. The proposed method of capitalization doesn't change the shape of the lowercase letter but only changes a property that leaves the basic shape of the letter intact. This design change makes text easier to read and allows children and illiterate adults to learn the alphabet more easily. It also transforms text to be readable by individuals who have learned the lowercase but not the uppercase letters. The proposed method of representing capitalization can also be used to signal capitalization in texts with unicase scripts.

### RELATED APPLICATIONS

This application relates to pending U.S. patent application Ser. No. 13/253,335, filed on Oct. 5, 2011, by the same inventor, Dominic William Massaro, entitled Method And System For Acquisition of Literacy.

### FIELD OF THE INVENTION

The subject invention relates to the reception, presentation, generation and reading of written language and its acquisition. More specifically, the invention is directed towards a method and system that implements capitalization by taking existing text and replacing uppercase letters with lowercase letters and changing one or more properties of the lowercase letters. In addition, the invention adds capitalization to unicase orthographies by changing one or more properties of its letters.

### BACKGROUND OF THE INVENTION

In many so-called bicameral orthographies such as the Latin, Cyrillic, Greek, Armenian, and Coptic alphabets, there are both upper and lowercase instances of each letter. Uppercase letters are used to signal capitalization. Like other forms of punctuation, capitalization in American English is used for first letters of sentences and proper nouns and proper adjectives and all the letters in abbreviations and acronyms. One goal of capitalization is to make reading easier so, for example, to recognize that “The” is a first word of the sentence “The girl talked to Leaf.” and that “Leaf” is a proper name as opposed to a leaf found on a tree.

However, other writing systems such as those used in unicase scripts including Chinese, Japanese, Korean Arabic, Farsi, Hebrew, and That have just a single case for each letter.

Qualitative shape differences often exist between the upper and lower case of letters such as the difference between English uppercase A and lowercase a. Other letters such as uppercase C and lowercase c do not have qualitative shape differences. The shapes of the English letters (A, B, D, E, F, G, H, I, J, L, M, N, Q, R, T, Y) are significantly different in upper and lowercase. The remaining letters differ mainly in size (C, K, O, P, S, V, W, X, Z).

Type fonts also differ in their legibility, and there has been considerable effort devoted to optimizing type fonts for reading. Given the increasing pervasiveness of electronic media, unconventional screens, and challenging reading conditions, optimizing type fonts becomes increasingly important. One advance is the Clearview typeface now used in highway signs to make them easier to see from a distance and in poor light or poor vision.

Type fonts also are important in learning to read. For bicameral scripts, educators agree that learning both cases is more difficult than just one but disagree about how to teach both cases. Although there is disagreement on when and how to teach both cases, children and illiterate adults currently have to learn them both to be successful readers.

Eliminating qualitative shape differences between capitalized and non-capitalized letters would make it much easier for children and illiterate adults to learn the alphabet and to learn to read. The justification for this claim is that it is much more difficult to learn different categories when the members within a given category are qualitatively different from one another.

Persons experience increasing processing difficulty when two qualitatively different characters have the same category name. Psychologists have demonstrated this fact in a variety of experiments. In one such experiment, two successive letters are presented in the same location and the subject has to indicate whether they have the same or different names. The two letters could be physically identical, identical in name only, or have different names. The uppercase letter A, for example, could be presented and followed by the uppercase letter A, the lowercase letter a, or the letter B or b. The results in many different experiments have shown that it takes subjects about 80 ms longer to indicate a “same name” when the two letters are shown in different cases than when they are shown in the same case. Thus, it takes about 80 ms longer to respond “same” to A followed by a (or a followed by A) than to respond to A followed by A (or a followed by a).

Letters like A and a require a superordinate categorization because there are qualitative differences in their shapes even though they represent the same category and they both have the same name. Letters like C and c only require a basic level categorization because they only differ quantitatively in size. Size differences do not dismantle visual categorization because the same object can be seen in many sizes. Different shapes, on the other hand, usually distinguish different categories and therefore would impede learning objects with different shapes within the same category. Psychological research has shown that items requiring basic level categorization (with only size or color differences within a category, for example) are much easier to learn and remember than items requiring superordinate categorization (with qualitative shape differences within a category).

Therefore a system that represents capitalization with size differences (or some other quantitative difference such as color, boldness, italics, and type font or any combination of these quantitative differences) rather than qualitative shape differences would be desirable. In the English alphabet, for example, upper and lowercase versions of the first letter might be a and a. This design change would allow children to learn the alphabet more easily because children would only be required to learn a basic level categorization.

Thus, it would be advantageous to provide a system that transforms input text into an output presentation format that signals capitalization by replacing uppercase letters with lowercase letters that have size or other differences. It follows that capitalization would still be signaled by the letter's physical characters but in a way that preserves its similarity to lowercase letters.

It would also be advantageous to transform the output of text entry, query and search systems to conform to such an output presentation format.

Currently, existing keyboards and touchpads have a “shift key” that is used to create an uppercase letter rather than a lowercase letter. This same type of implementation could be used to indicate capitalization in terms of a quantitative difference rather than a qualitative difference.

In addition, there are now many automated systems that generate text such as speech to text or automated speech recognition. Therefore it would also be advantageous transform text from these systems into such an output presentation format.

Languages with unicase alphabets could also benefit from the proposed method of capitalization. Capitalization putatively facilitates reading because it makes the text easier to understand. Therefore, a language with unicase orthography could instantiate rules for capitalization. For example, it could specify that the first letter of the first word of a sentence and the first letter of a proper noun and a proper adjective should be capitalized to facilitate reading and understanding.

### SUMMARY OF THE DESCRIPTION

The present invention exploits current knowledge and developments in behavioral science and technology to provide devices, systems, and methods for automatically transforming uppercase letters into lowercase letters that are formatted to display differences in size and/or other noticeable differences relative to the neighboring text. This signaling of capitalization preserves the category similarity of the substituted letters to standard lowercase letters because it does not change the qualitative configuration of the letters.

The present invention includes: 1) an automated input system to provide digitized electronic text or to optically scan an electronic image of printed text or to capture the image of a text such as a page of a physical book; 2) a processing system to identify all letters, their font, their size, and their case and character formatting, 3) to change uppercase letters to lowercase; 4) to then change the character formatting of these lowercase letters to generate output text; and 5) an output system to display, transmit, or print output text in either electronic or paper format.

In one embodiment, the subject invention provides a method for transforming the output of text input, query and search systems to conform to the proposed presentation format.

In yet another embodiment, the subject invention includes a computer-implemented method for processing text, including receiving a portion of text from an input device, identifying each uppercase letter in the portion of text, substituting a corresponding lowercase letter for each of the identified uppercase letters, applying specified presentation rules to each of the substituted lowercase letters to obtain output text, and providing the output text to an output device.

In still another embodiment, the subject invention includes a device, including a processor that is programmed to perform actions, including receiving a portion of text from an input device, identifying each uppercase letter in the portion of text, substituting a corresponding lowercase letter for each of the identified uppercase letters, applying specified presentation rules to each of the substituted lowercase letters to obtain output text, and providing the output text to an output device.

In yet another embodiment, the subject invention includes a computer-implemented method for processing text, including receiving a portion of text from an input device, determining if the received portion of text is in a unicase alphabet, if the determined text is in a unicase alphabet, identifying the first letter of each sentence and the first letter of proper nouns in the portion of text, applying specified presentation rules to each of the identified letters to obtain output text, and providing the output text to an output device.

Another embodiment is aimed at visually-challenged persons who read Braille with their fingers. Braille letters are represented by the configuration of the raised bumps in each rectangular block corresponding to a character. Braille specifies capitalization by adding a character with a single dot before the letter character. Given that Braille is currently being developed for dynamic displays with micro-actuators to create the bumps, the micro-actuator intensity may be increased which results in an increase in the perception of size. This implementation would signal capitalization directly without requiring the extra characters now being used.

### BRIEF DESCRIPTION OF THE DRAWINGS

The best way to understand and appreciate the subject invention is in conjunction with the attached drawings. The drawings are summarized briefly below and then referred to in the Detailed Description that follows.

FIG. 1 illustrates a list of printed words and sentences in which uppercase letters are represented by lowercase letters of increased size, and different character formats;

FIG. 2 illustrates a image and letter processing (ILP) system that accepts input text from a variety of input sources and generates output text by applying presentation rules to the input text;

FIG. 3 provides a simplified block diagram of an image and letter processing (ILP) device that accepts input text from a variety of input sources and generates output text by applying a set of presentation rules; and

FIG. 4 describes an overall method performed by an image and letter processing (ILP) device for receiving, analyzing and transforming input text into output text.

### DETAILED DESCRIPTION

The drawings are now used to describe the subject invention, but it should be observed that it is possible to implement the innovation without these specific details. The description provides specific details to help the reader understand the invention.

Many of the terms used in this description, such as component and system, refer to computers, including their hardware and software. Other terms are specifically defined.

As used herein the following terms have the meanings given below:

Capitalization—means the act or process of capitalizing. For example, in English and most other languages using the Roman alphabet, the first letter of a word is capitalized to indicate the beginning of a sentence or to indicate a proper noun or proper adjective. In American English, all the letters in abbreviations and acronyms are usually capitalized.

Reader—means a person that is the intended recipient of written language text presented by the subject invention.

Sensor data—means encoded information or input data from a device that captures data, typically using a sensor. Example capture devices include inter alia a digital camera, digital camcorder, voice recorder, bar code reader, GPS, microphone, tablet computer, personal computer, laptop computer and mobile phone or smart phone.

Optical Character Recognition—refers to an automated process of analyzing a digital image to extract text or other characters in a digital format. Thus, a digital image representing a page of text may be transformed into a sequence of characters or symbols.

Uppercase—means letters that signal capitalization. The uppercase letters in English are ABCDEFGHIJKLMNOPQRSTUVWXYZ.

Lowercase—means letters that do not signal capitalization. The lowercase letters in English are abcdefghijklmopqrstuvwxyz.

Font or Type Font—means the style of a set of characters. Also referred to as typeface.

Size—refers the size or magnitude of the type font.

Default font size—the size of the text neighboring a selected letter. For example, the size of the text in the word that includes the letter may be taken as the default text size. Or if the word includes letters of different sizes then the size of the largest letter may be selected as the default text size.

Default font characteristics (excluding size)—The font characteristics of the text neighboring a selected letter, excluding its size. For example, the neighboring letters may all be italics or bold or the color red. If no special formatting is applied the default font characteristic is said to be regular. Taken together the default font size and the default font characteristics (excluding size) of a letter may be referred to as its default font characteristics.

Presentation format—refers to the letter or character formatting of text processed by the present invention. The presentation format is obtained by applying presentation rules that change the formats of selected letters in a portion of text.

Presentation rule—refers to a description of a change to be applied to the format of a character, or letter, of text to produce output text. Character formats, or character properties, include type font, italics, underline, underline style, background color, strikethrough, size, line strength, color, shadow, outline, embossing and the like. Thus a presentation rule might be to change a letter to the TIMES ROMAN font; or to increase the size of a letter to 14 point.

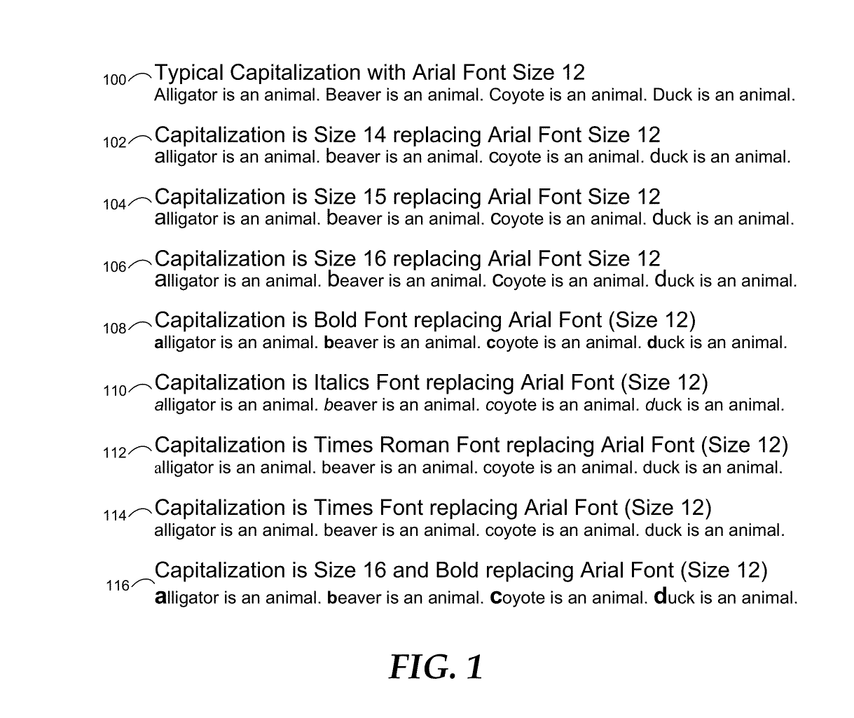

FIG. 1 illustrates a list of printed words in which uppercase letters are represented by lowercase letters of increased size, and different character formats. In each of examples 100-116 the first line describes how capitalization is signaled in the sentences on the second line. Example 100 shows typical capitalization by using uppercase letters using the Arial font. Examples 102-114 give examples in which the uppercase letters A, B, C, and D, each of which begins a sentence, have been replaced by lowercase letters and the presentation format of lowercase letters has been modified by making a single format change. Example 116 give an examples in which the uppercase letters A, B, C, and D, each of which begins a sentence, have been replaced by lowercase letters and the presentation format of lowercase letters has been modified by making two format changes. In examples 102-116 the character formatting of each replaced letter is modified by performing one or two of the following format changes: increasing the size of the letter, bolding the letter, italicizing the letter, and changing the font. Additional examples of character format changes include changing the color of the lowercase letter that represents an uppercase letter, underlining the lowercase letter or a combination of any of the abovementioned presentation formats. Character format changes in addition to those mentioned hereinabove may also be applied without departing from the scope or spirit of the subject invention.

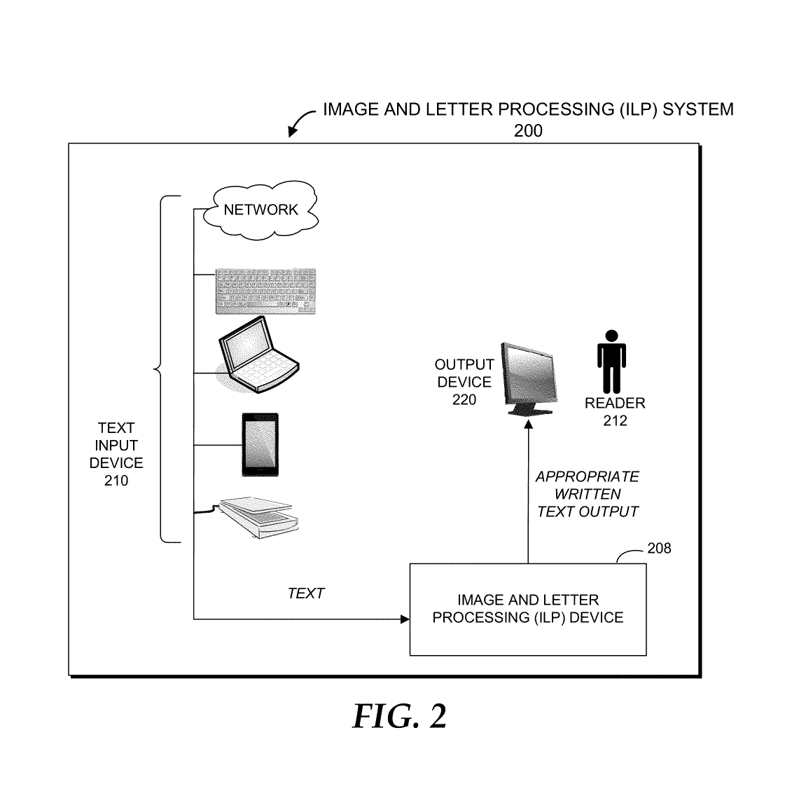

FIG. 2 illustrates a image and letter processing (ILP) system 200 that accepts input text from a variety of input sources and generates output text by applying a set of presentation rules. ILP system 200 includes the following components: one or more text input devices 210 that generate text input to an image and letter processing (ILP) device 208 for processing and transforming text, and one or more output devices 220 such as a computer monitor or printer and a human reader 212 that reads the output text from output device 220.

Text input device 210 includes any type of device or network connection that can provide or communicate text or data that represents text to an ILP device 208. Thus, text input device 210 may include inter alia a computer keyboard, any type of computer including desktop, laptop and pad, mobile phone or smartphone, a scanner that optically scans printed text, and provides a digital image or which performs optical character recognition and generates text, bar code readers and RFID devices. Text input device 210 also includes devices such as a microphone, voice recorder or CD or DVD player that provides speech input. Text input device 210 also includes network connections such as an internet connection, or USB drive that provides text. The text may be in the form inter alia of a book, magazine, email or text message.

ILP device 208 is a computing device that typically includes a processor, memory for programs and data and permanent data storage. Examples of types of devices that may be employed as an ILP device include mobile devices, smart phones, tablet computers, personal computers, desktop computers, and server computers. In addition, the functions and components of device 208 may be split across multiple computers.

Output device 220 displays, communicates, or prints output text generated by ILP device in a manner suitable for reader 212. Output device 220 includes any device that can display, print, communicate or otherwise present text to reader 212. Output device 220 may include a display monitor, a television, a display embedded in a mobile device, laptop computer, tablet or pad computer, or a tactile vibrator. Output device 220 also includes inter alia a printer for physical print output and a USB drive or Internet connection for remote text output.

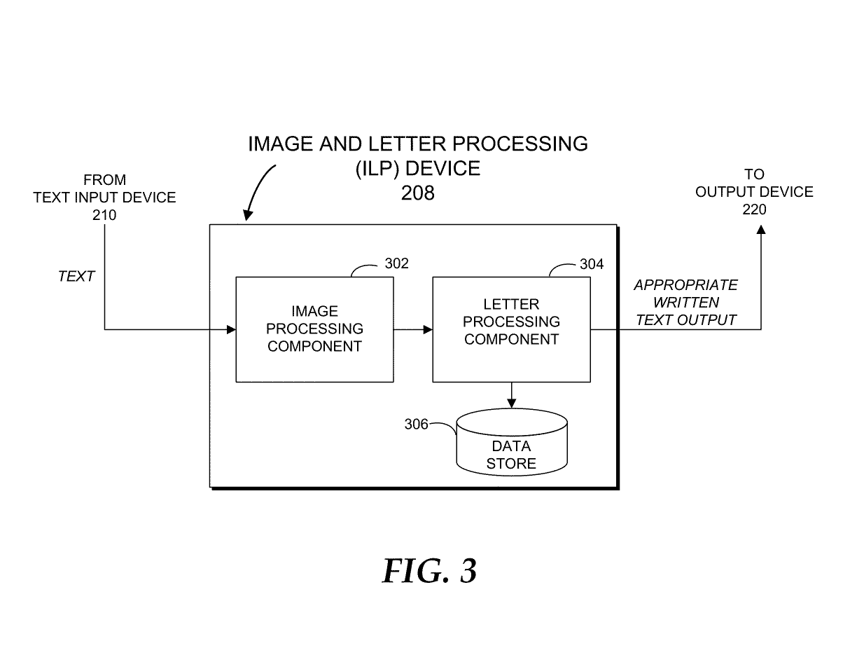

FIG. 3 provides a simplified block diagram of an image and letter processing (ILP) device 208 that accepts input text from a variety of input sources and generates output text by applying a set of presentation rules. Typically, an image processing component 302 running in ILP device 208 receives text from text input device 210. Image processing component 302 may be included in a commercial or proprietary application such as an email or text messaging program that receives and displays, forwards, stores, or otherwise outputs the received text to a device such as a display or to another application such as a messaging application running in another device. Alternatively, image processing component 302 may be a driver or separate utility, such as a keyboard driver or OCR library associated with a scanner. In addition, image processing component 302 may include automatic speech recognition functions that analyze speech and convert it to text. In some embodiments, image processing component 302 may run inside of text input device 210 and output text directly to letter processing component 304.

Letter processing component 304 receives text from image processing component 302, analyzes it, identifies letters in the text to be changed and applies presentation rules to the identified letters to generate output text that is sent to output devices 220. In a preferred embodiment, letter processing component 304 obtains presentation rules from a data store 306. In a preferred embodiment, presentation rules include changing uppercase letters to lowercase letters and changing the size, font, color, or other presentation aspect of the lowercase letter.

A presentation rule for changing an identified letter may take into account the default font size and default font characteristics (excluding size). In a preferred embodiment, used for the English language, presentation rules are given as:
If the letter is uppercase, change it to lowercase and make it n points larger than the default text size.
If the font of the characters in the word are all regular, i.e. no special character formatting is used such as bold or italic, then italicize the lowercase letter.
If the uppercase letter occurs alone, i.e. is only letter in the word, then the font characteristics of the neighboring adjacent words are determined. The uppercase letter is changed to lowercase and is made n points larger than the size of the font of the neighboring words.
Similarly, if the font of the neighboring words is regular, then italicize the lowercase letter.

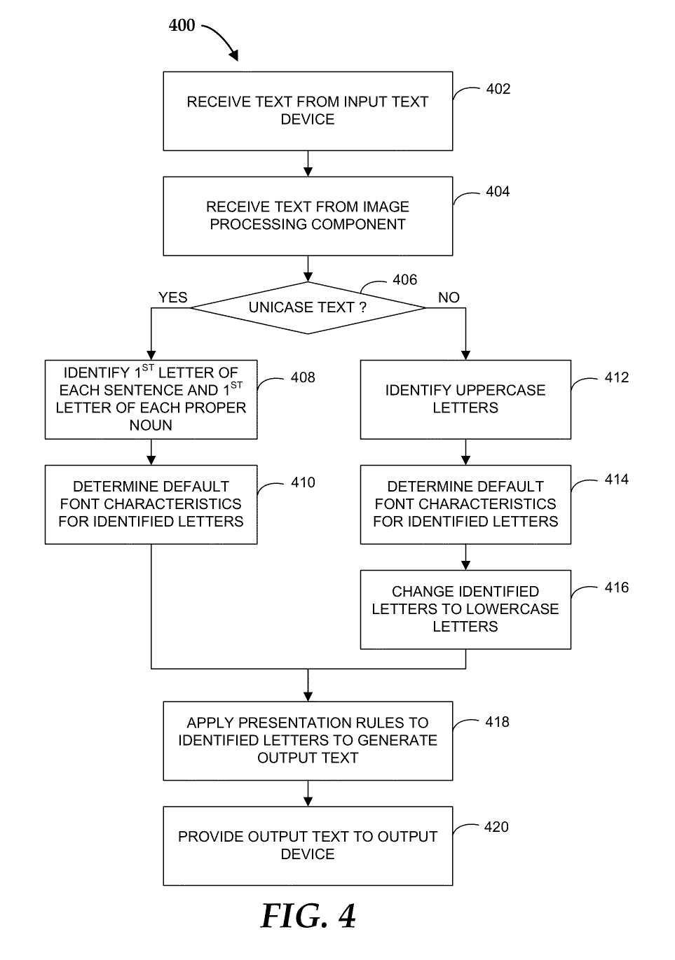

In another embodiment, the presentation rule is to identify all uppercase letters and to transform them into slightly larger lowercase letters, for example 10% to 20% larger than the default font size, using the same font. However, the general method performed by letter processing component 304, described below with reference to FIG. 4, applies to any type of presentation rule and is capable of generating a wide range of output formats.

In one embodiment, presentation rules to be applied to input text to transform it into output text are stored in a data store 306. Data store 306 may be provided by virtually any mechanism usable for storing and managing data, including but not limited to a file, a folder, a document, a web page or an application, such as a database management system. Presentation rules, which may be expressed in XML or another language, indicate the transformation to apply to input text to produce output text. The rules may be conditional, i.e. they may be applied only in some instances, for example based on the age or skill of the reader or based on the type of output device. Further, different sets of rules may be applied to different readers or in different conditions.

In one embodiment, ILP device 208 may be a smart phone and input device 210 may be the smart phone's keyboard. Image processing component may be a keyboard driver that receives keystrokes from the keyboard. Letter processing component 304 applies presentation rules to the characters received from the keyboard and outputs the characters to output device 220 which in this embodiment is the smart phone's display.

FIG. 4 describes an overall method performed by an image and letter processing (ILP) device 208 for receiving, analyzing and transforming input text into output text. At step 402 image processing component 302 running in ILP device 208 receives a portion of text from text input device 210. The portion may be a sentence, a paragraph, a page, an article, a book or other amount of text. The text may be in the format of a scanned image or coded, for example in bar code form. If the portion of text is not in character format then image processing component 302 decodes the text.

Next, at step 404 letter processing component 404 receives the text from image processing component 302. The text may be intended for display, print or communication, for example as a text or email. Letter processing component 304 may intercept this text, i.e. from a printer or display driver.

At step 406 a determination is made as to whether the text is unicase or if it derives from a unicase alphabet. If so, processing continues at step 408. If not, then the alphabet includes upper and lower case and processing continues at step 412.

At step 408 letter processing component 304 analyzes the text from image processing component 302 and identifies the first letter of each sentence in the text as well as the first letter of any proper noun.

At step 410 letter processing component 304 identifies the default font characteristics, i.e. the default font size and default font characteristics (excluding size), for each identified letter. Processing then continues at step 418.

At step 412 letter processing component 304 analyzes the text from image processing component 302 and identifies all uppercase letters included in the text.

At step 414 letter processing component 304 determines the default font characteristics, i.e. the default font size and default font characteristics (excluding size), for each identified letter.

At step 416 letter processing component 304 substitutes each of the uppercase letters identified in the preceding step with lowercase letters.

At step 418 letter processing component 304 uses presentation rules to transform each of the identified letters into appropriate output text.

Finally, at step 420 letter processing component 304 provides the appropriate output text to output device 220.

Given the above description with hypothetical examples, it is understood that persons skilled in the art will agree that there are several embodiments that follow the methods, devices and systems described.

What is claimed is:

1. A computer-implemented method for processing text, comprising:
receiving a portion of text from an input device;
identifying each uppercase letter in the portion of text;
substituting a corresponding lowercase letter for each of the identified uppercase letters;
applying specified presentation rules to each of the substituted lowercase letters to obtain output text; and
providing the output text to an output device.

2. The method of claim 1, wherein a presentation rule specifies a change to the format of a character of text.

3. The method of claim 2, wherein the specified presentation rules are selected from the group consisting of: increase the size of a character to a specified size; change the font of a character to a specified font; change the color of a character to a specified color; bold a character; and italicize a character.

4. The method of claim 1 further comprising determining default font characteristics for each of the identified letters and wherein said applying is based in part on said determined default font characteristics.

5. The method of claim 1 further comprising storing said presentation rules in a data storage and wherein said applying presentation rules comprises retrieving the presentation rules from the data storage.

6. The method of claim 1, wherein the input device is selected from the group consisting of a smartphone, a tablet or pad computer, a laptop computer, a keyboard, a barcode reader, a RFID reader, and an Internet connection.

7. The method of claim 1, wherein the output device is selected from the group consisting of a computer display, a printer and an Internet connection.

8. A device, comprising a processor that is programmed to perform actions, comprising:
receiving a portion of text from an input device;
identifying each uppercase letter in the portion of text;
substituting a corresponding lowercase letter for each of the identified uppercase letters;
applying specified presentation rules to each of the substituted lowercase letters to obtain output text; and
providing the output text to an output device.

9. The device of claim 8, wherein a presentation rule specifies a change to the format of a character of text.

10. The device of claim 9, wherein the specified presentation rules are selected from the group consisting of: increase the size of a character to a specified size; change the font of a character to a specified font; change the color of a character to a specified letter; bold a character; and italicize a character.

11. The device of claim 8 wherein said processor is programmed to perform actions, further comprising determining default font characteristics for each of the identified letters and wherein said applying is based in part on said determined default font characteristics.

12. The device of claim 8 further comprising a data storage for storing said presentation rules and wherein said applying presentation rules comprises retrieving the presentation rules from the data storage.

13. The device of claim 8, wherein the input device is selected from the group consisting of a smartphone, a tablet or pad computer, a laptop computer, a keyboard, a barcode reader, an RFID reader, and an Internet connection.

14. The device of claim 8, wherein the output device is selected from the group consisting of a computer display, a printer and an Internet connection.

15. A computer-implemented method for processing text, comprising:
receiving a portion of text from an input device;
determining if the received portion of text is in a unicase alphabet;
if the determined text is in a unicase alphabet, identifying the first letter of each sentence and the first letter of proper nouns in the portion of text;
applying specified presentation rules to each of the identified letters to obtain output text; and
providing the output text to an output device.

16. The method of claim 15, wherein a presentation rule specifies a change to the format of a character of text.

17. The method of claim 16, wherein the specified presentation rules are selected from the group consisting of: increase the size of a character to a specified size; change the font of a character to a specified font; change the color of a character to a specified color; bold a character; and italicize a character.

18. The method of claim 17 further comprising determining default font characteristics for each of the identified letters and wherein said applying is based in part on said determined default font characteristics.

19. The method of claim 15, wherein the input device is selected from the group consisting of a smartphone, a tablet or pad computer, a laptop computer, a keyboard, a barcode reader, a RFID reader, and an Internet connection.

20. The method of claim 15, wherein the output device is selected from the group consisting of a computer display, a printer and an Internet connection.
